(19) United States
(12) Patent Application Publication
(10) Pub. No.: US 2010/0223366 A1
(43) Pub. Date: Sep. 2, 2010

(54) AUTOMATED VIRTUAL SERVER DEPLOYMENT

(75) Inventors: Arnold Cruz Ebreo, Freehold, NJ (US); William Scott Kuhr, Cincinnati, OH (US); David Edward Pascoe, Dayton, NJ (US); Richard Scott Pyburn, SR., Hazlet, NJ (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/395,350

(22) Filed: Feb. 27, 2009

(51) Int. Cl. G06F 15/177

(52) U.S. Cl. 709/222

(57) ABSTRACT

A method and system for deploying a virtualized server system, referred to as a local zone, includes establishing a network connection to a pre-installed global operating system, referred to as a global zone. The network connection may be established from a computing device configured to receive user input and transmit configuration commands for creating the local zone. An application, which accesses a file system configured on a logical volume configured using disk groups in the local zone, may be installed and configured for execution.

### BACKGROUND

1. Field of the Disclosure

The present disclosure relates to deployment of computer systems and, more particularly, to deployment of virtualized servers.

2. Description of the Related Art

Modern server systems are typically configured as virtualized environments in an effort to allocate processing and storage resources. Virtualized server farms provide platforms that leverage economies of scale for both hardware costs and processing capabilities. The deployment of virtualized servers typically involves a number of operations.

### BRIEF DESCRIPTION OF THE DRAWINGS

FIG. 1 is a block diagram of selected elements of an embodiment of a virtualized server environment;

FIG. 2 is a block diagram of selected elements of an embodiment of local zone;

FIG. 3 is a block diagram of selected elements of an embodiment of a server deployment process; and

FIG. 4 is a block diagram of selected elements of an embodiment of a computing device.

### DESCRIPTION OF THE EMBODIMENT(S)

In one aspect, a disclosed method for deploying a server system includes establishing a network connection to a pre-installed global operating system of the server system, and creating a local zone on the server system using the network connection. Creating the local zone may include additional operations based on user input. At least one disk group may be created for use with the local zone. The local zone may be created based on a first user input indicating desired properties of the local zone. The at least one disk group may be assigned to the local zone based on a second user input indicating a desired disk group. At least one logical volume may be configured on the local zone based on a third user input indicating an assigned disk group and desired properties of a logical volume. At least one file system on the at least one logical volume may be configured based on a fourth user input indicating desired properties of a file system.

In some embodiments, the method further includes assigning logical unit numbers (LUN) respectively representing logical partitions provided by a storage-area network (SAN) to the at least one disk group. The operations for creating the at least one disk group may include assigning an LUN representing a logical partition provided by at least one local storage device to the at least one disk group. The desired properties of the local zone may include a zone identifier, a physical interface, and a central processing unit (CPU) utilization factor. The desired properties of the logical volume may include a volume identifier and a volume size. The desired properties of the file system may include a file system mount point.

In certain embodiments, the operations for creating the local zone may include adding user accounts on the local zone based on a fifth user input indicating user account information. The operations for creating the local zone may further include configuring an application on the local zone, wherein the application accesses the at least one file system. The operations for creating the local zone may still further include rebooting the local zone, and executing the application from the local zone.

In another aspect, a disclosed computing device for deploying a server system includes a processor, and memory media accessible to the processor, including processor executable instructions. The processor executable instructions may be executable to use the network adapter to establish a network connection to a pre-installed global operating system of the server system, and create a local zone on the server system using the network connection responsive to receiving user input. The local zone may be configured to provide access to at least one file system mounted on at least one disk group available to the local zone.

In some instances, the processor executable instructions to create the local zone may include processor executable instructions to create at least one disk group for use with the local zone, and create the local zone responsive to receiving first user input indicating desired properties of the local zone. The desired properties of the local zone may include a zone identifier, a physical interface, and a CPU utilization factor. The processor executable instructions to create the local zone may include processor executable instructions to assign the at least one disk group to the local zone responsive to receiving second user input indicating a desired disk group. The processor executable instructions to create the local zone may include processor executable instructions to configure at least one logical volume on the local zone responsive to receiving a third user input indicating an assigned disk group on which the logical volume is configured. The processor executable instructions to create at least one disk group may further comprise processor executable instructions to assign LUNs respectively representing logical partitions on an SAN to the at least one disk group. The processor executable instructions to create the local zone may include processor executable instructions to configure at least one file system corresponding to the at least one logical volume responsive to receiving a fourth user input indicating desired properties of a file system.

In some embodiments, the system further includes processor executable instructions to reboot the local zone, and execute an application from the local zone, such that the application accesses the at least one file system.

In still another aspect, a disclosed computer-readable memory media includes executable instructions for deploying a server system. The instructions may be executable to create at least one disk group for use with a local zone, and create the local zone responsive to receiving a first user input indicating desired properties of the local zone. The instructions may further be executable to assign the at least one disk group to the local zone responsive to receiving a second user input indicating a desired disk group, configure at least one logical volume on the local zone responsive to receiving a third user input indicating an assigned disk group on which the logical volume is configured, and configure at least one file system on the at least one logical volume responsive to receiving a fourth user input indicating desired properties of a file system. The first, second, third, and fourth user inputs may be used to generate instructions for sending over the network connection.

In some instances, the desired properties of the logical volume may include a volume identifier and a volume size. The desired properties of the file system may include a file system mount point. The memory media may further include instructions executable to add user accounts on the local zone responsive to receiving fifth user input indicating user account information. The memory media may still further include instructions executable to reboot the local zone, and execute an application from the local zone, while the application accesses the at least one file system.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

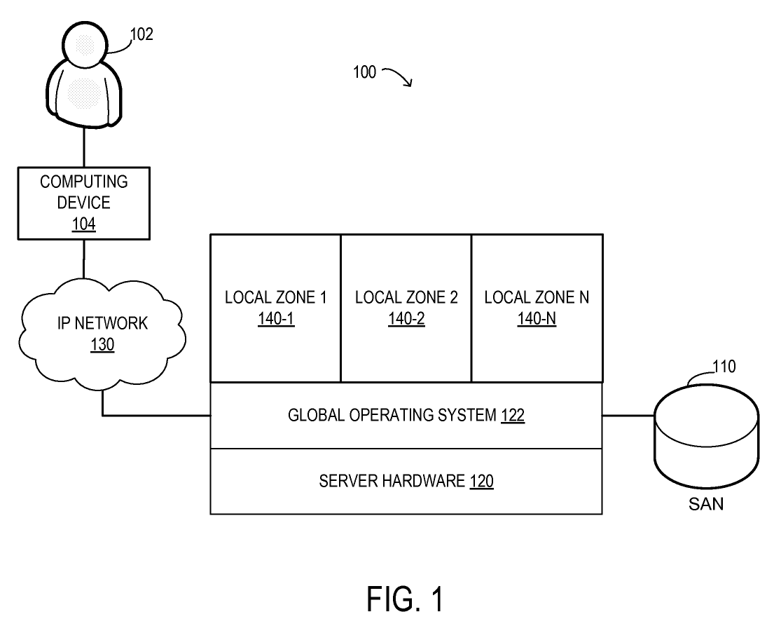

Referring now to FIG. 1, a block diagram of selected elements of a virtualized server environment (VSE) 100 configured to provide a plurality of virtualized servers is shown. Although shown in FIG. 1 as a singular platform, VSE 100 may represent a multitude of individual hardware elements or platforms, which may collectively be referred to as a “server farm.” In other words, individual elements depicted in FIG. 1 may themselves represent complex systems or aggregate components of systems.

As shown in FIG. 1, server hardware 120 represents the physical computing platform providing processing and interfacing capabilities for VSE 100. Accordingly, server hardware 120 may include one or more individual computer systems. In some embodiments, server hardware 120 may include a large number of processors configured for parallel computing. Server hardware 120 may be installed in a server farm, or other specialized location, which provides sufficient power and cooling to physically operate computer systems of various form factors. Server hardware 120 also includes physical interfaces for networking and peripheral equipment, as desired. In some embodiments, server hardware 120 may include, or be coupled to, monitoring and management systems for safeguarding operation (not shown in FIG. 1).

Depicted in FIG. 1 is also global operating system (GOS) 122, which may be installed on server hardware 120. GOS 122 may represent a type of operating system that is capable of installing and executing virtualized instances of a computing environment, such as a virtualized server. In some embodiments, GOS 122 may be an operating system from Sun Microsystems, Inc., VMWare, Inc, Microsoft Corp., a LINUX/UNIX—type operating system, or another operating system. Furthermore, GOS 122 may be configured to receive and execute commands issued remotely via a network interface, as will be discussed in detail below.

Also shown in FIG. 1 is SAN 110, which provides storage capacity via GOS 122. SAN 110 may be partitioned into segments, partitions, or volumes, which may be accessible to GOS 122. In certain cases, a logical partition in SAN 110 may be accessed using a particular LUN. SAN 110 may itself represent a large, scalable computing environment, and may be remotely located from server hardware 120. The interface between SAN 110 and GOS 122 may be physically realized via an interface provided by server hardware 120. As will be described in detail below, SAN 110 may provide partitions for configuration and use by virtualized servers in VSE 100.

The virtualized instances of a computing environment in FIG. 1 are shown as local zones 140, while GOS 122 may be referred to as a “global zone.” GOS 122 may support a number of local zones 140, shown in FIG. 1 as local zone 1 140-1, local zone 2 140-2, and so on, up to local zone N 140-N. In some embodiments, N may be in the dozens or hundreds. Each local zone 140 may be allocated a controllable portion of computing resources associated with computer hardware 120, such as processing capacity, program memory, bus transfer capacity, and/or storage capacity.

Accordingly, GOS 122 may be configured to accept network commands to install and configure local zones 140. Internet-protocol (IP) network 130 may provide network connectivity between GOS 122 and computing device 104 operated by user 102. In some embodiments, IP network 130 may enable user 102 to operate computing device 104 from a remote location. Computing device 104 may be a desktop or laptop computer system, or may represent a portable wireless computing device configured to access IP network 130. In some cases, multiple users, such as user 102, may concurrently access GOS 122 from different computing devices, such as computing device 104, for the purpose of creating and configuring local zones 140.

In FIG. 1, user 102 may represent a system administrator for VSE 100. User 102 may be responsible for installing new virtual servers, such as local zones 140, on VSE 100, or for maintaining existing virtual servers. In some instances (not depicted in FIG. 1), user 102 may directly access server hardware 120 for administrating VSE 100. As shown in FIG. 1, user 102 may access GOS 122 via IP network 130 from a remote location using computing device 104.

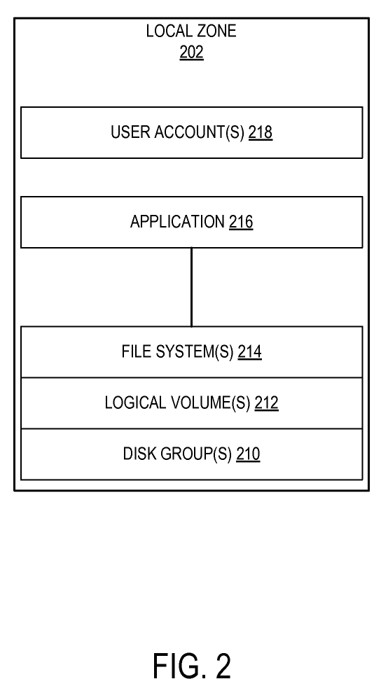

Turning now to FIG. 2, a block diagram of selected elements of an embodiment of local zone 202 is illustrated. In some embodiments, local zone 202 represents an exemplary instance of local zone 140 in FIG. 1 shown in further detail. User 102 (see FIG. 1) may provide user input for defining desired properties of local zone 202, such as a zone identifier, a physical interface, and/or a CPU utilization factor.

As shown in FIG. 2, local zone 202 may be configured with one or more disk group(s) 210, which represent virtualized storage partitions. Upon creation of disk group(s) 210, one or more real partitions from a storage device or system are allocated to local zone 202. In some cases, disk group(s) 210 are mapped using LUNs of storage partitions or volumes provided by SAN 110 (see FIG. 1), whereby the mapping may encapsulate one or more storage elements into a disk group. In certain instances, a local storage device (not shown) to server hardware 120 (see FIG. 1) is accessed using a particular LUN to create at least some of disk group(s) 210. Once created, disk group(s) 210 may be accessed as a local partition in local zone 202. Disk group(s) 210 may be created prior to the creation of local zone 202, and then may be configured for access by local zone 202. In certain embodiments, user 102 (see FIG. 1) provides user input for assigning disk group(s) 210 to local zone 202.

Also in FIG. 2, local zone 202 may be configured with one or more logical volume(s) 212. Logical volume(s) 212 may be configured using one of disk group(s) 210, and provide a formatted storage address space to local zone 202. In certain embodiments, user 102 (see FIG. 1) provides user input for configuring the desired properties of logical volume(s) 212 to local zone 202, such as a volume identifier and/or a volume size.

In FIG. 2, local zone 202 may be configured with one or more file system(s) 214. File system(s) 214 may be configured on logical volume(s) 212 and provide a hierarchical organization of data files and data directories to local zone 202. Data files stored under file system(s) 214 may be accessed using a specifier for the logical volume and the hierarchical file location, also know as a file path. In certain embodiments, user 102 (see FIG. 1) provides user input for configuring the desired properties of file system(s) 214 to local zone 202, such as a file system mount point. In some embodiments, configuration of file system(s) 214 may be optional.

Application 216, shown in FIG. 2, may further be installed on local zone 202. In some embodiments, executing application 216 may represent the main functional purpose for creating local zone 202, such that the properties of local zone 202 are tailored to the requirements of application 216. Application 216 may be configured to access file system(s) 214 for storing and retrieving data objects, such as data files. Application 216 may itself be installed on file system(s) 214 in certain embodiments. In some cases, file system(s) 214 may be proprietary to application 216, for example, when application 216 is a database server. In certain embodiments, user 102 (see FIG. 1) provides user input for configuring the desired properties of application 216.

Further depicted in FIG. 2 is one or more user account(s) 218. User account(s) 218 may govern how users of local zone 202 access application 216 or file system(s) 214. Different users with different levels of access may be configured using user account(s) 218. In certain embodiments, user 102 (see FIG. 1) provides user input for adding user accounts, such as user account information. Thus, upon completed configuration, local zone 202 represents an independent, virtualized server environment that may be rebooted without affecting other local zones.

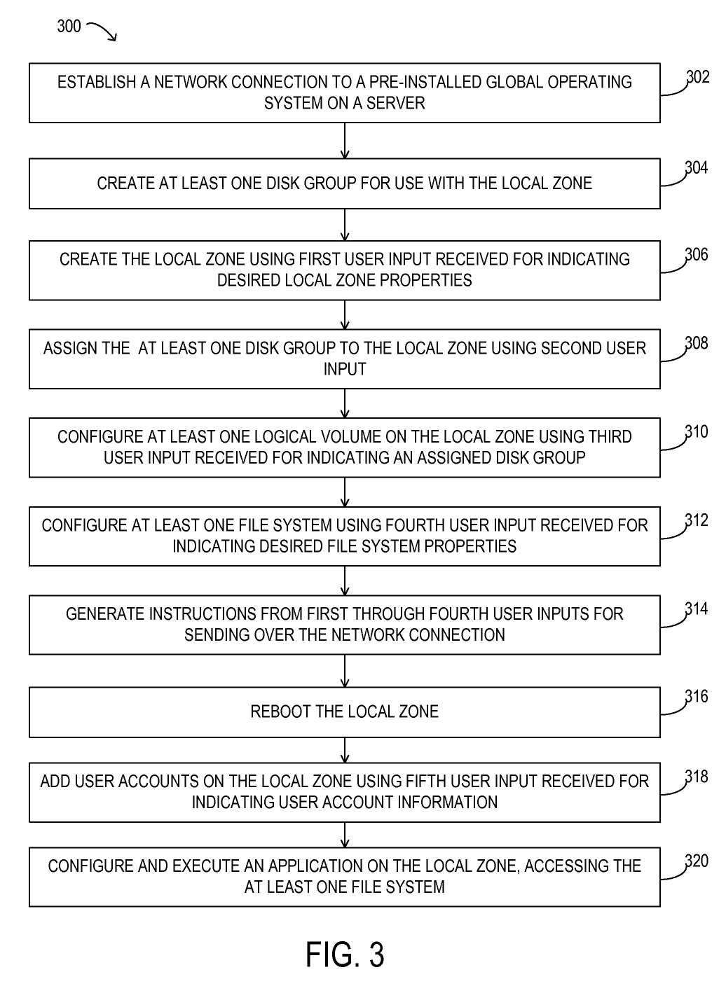

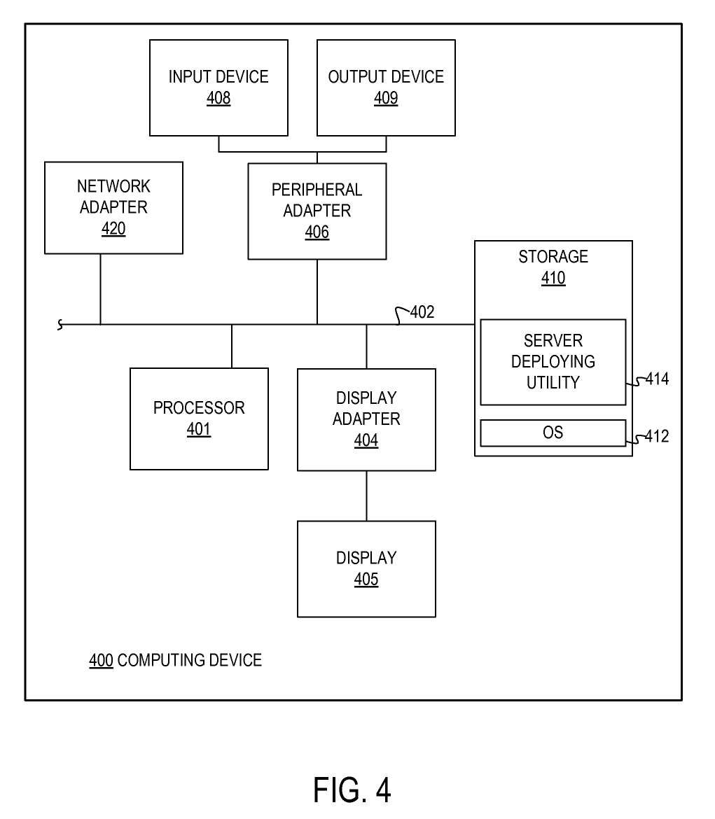

Turning now to FIG. 3, a block diagram of selected elements of an embodiment of n server deployment process 300 is illustrated. It is noted that VSE 100 (see FIG. 1) may be configured to execute process 300. In particular, an application, such as server deploying utility 414 (see FIG. 4), executing on computing device 104 may receive user input from user 102 and send commands to GOS 122 for executing server deployment process 300. The operations described below in server deployment process 300 may be individually sent to GOS 122 for immediate execution. In come cases, operations may be collectively sent to GOS 122, for example as an execution script, after different types of user input has been provided. User 102 may be provided an input mask for entering user input and for checking the validity of user input. In certain embodiments, one or more operations in server deployment process 300 may be optional.

A network connection to a pre-installed GOS on a server may be established (operation 302). For example, computing device 104 may establish a connection via IP network 130 to GOS 122 (see FIG. 1) in operation 302. Then, at least one disk group may be created for use with local zone(s) (operation 304). The disk group(s) may be created by assigning one or more LUN(s) representing logical partitions. The logical partitions may be provided by an SAN, such as SAN 110, or by a local storage device on the server, such as on server hardware 120 (see FIG. 1). In some cases, disk group(s) are created in advance of deployment or creation of a local zone, such as local zone(s) 140. In some cases, GOS 122 may be configured to provide access to logical partitions.

The local zone may be created using a first user input received for indicating desired local zone properties (operation 306). User 102 may provide the first user input to computing device 104. The first user input may include a zone identifier, a physical interface, and/or a CPU utilization. The at least one disk group may be assigned to the local zone using a second user input (operation 308). The second user input may include an indication of the at least one disk group.

At least one logical volume may be configured using a third user input received for indicating an assigned disk group (operation 310). The at least one logical volume may be created using the assigned disk group as the logical partition. The third user input may further include a volume identifier and a volume size for the at least one logical volume. At least one file system may be configured using a fourth user input for indicating desired file system properties (operation 312). The at least one file system may be configured on a logical volume, which was configured in operation 310. The fourth user input may further include a file system mount point.

Instructions from the first through the fourth user inputs may be generated for sending over the network connection (operation 314). The instructions may comply with a syntax expected by GOS 122. In some embodiments, operation 314 may be repeated after different kinds of user input is received (not shown in FIG. 3), such that instructions are sent to GOS 122 repeatedly during process 300. The instructions may be generated in the form of an execution script, or batch file, and sent collectively to GOS 122. Operation 314 may further include receiving an indication that the instructions were received by GOS 122, and/or receiving an indication that the instructions were successfully executed by GOS 122.

The local zone may then be rebooted (operation 316). Instructions from computing device 104 may be sent to GOP 122 for causing the local zone to reboot. As a result of performing operations 304-314, a bootable local zone may have been successfully configured. Upon successfully rebooting the local zone in operation 316, the local zone configuration may be considered verified. If the local zone does not successfully reboot in response to receiving an instruction, then the local zone configuration may be considered faulty, and remediation steps may be undertaken. In some cases, process 300, or portions thereof, may be repeated as one or more remediation steps (not shown in FIG. 3).

User accounts may then be added to the local zone using a fifth user input received for indicating user account information (operation 318). The user accounts on the local zone may determine the level of access to resources enjoyed by users of the local zone. The user account information may include identities of network users and administrators for VSE 100 (see FIG. 1).

An application, which accesses the at least one file system, may be configured and executed on the local zone (operation 320). The application, such as application 216 (see FIG. 2), may represent the desired functionality for the local zone. The application itself may be installed on a file system available to the local zone. In some embodiments, successful execution of the application may be considered an indication that process 300 was successfully completed.

Referring now to FIG. 4, a block diagram illustrating selected elements of an embodiment of a computing device 400 is presented. In the embodiment depicted in FIG. 4, device 400 includes processor 401 coupled via shared bus 402 to storage media collectively identified as storage 410.

Device 400, as depicted in FIG. 4, further includes network adapter 420 that interfaces device 400 to a network (not shown in FIG. 4). In embodiments suitable for use in server deployment, device 400, as depicted in FIG. 4, may include peripheral adapter 406, which provides connectivity for the use of input device 408 and output device 409. Input device 408 may represent a device for user input, such as a keyboard or a mouse, or even a video camera. Output device 409 may represent a device for providing signals or indications to a user, such as loudspeakers for generating audio signals.

Device 400 is shown in FIG. 4 including display adapter 404 and further includes a display device or, more simply, a display 405. Display adapter 404 may interface shared bus 402, or another bus, with an output port for one or more displays, such as display 405. Display 405 may be implemented as a liquid crystal display screen, a computer monitor, a television or the like. Display 405 may comply with a display standard for the corresponding type of display. Standards for computer monitors include analog standards such as video graphics array (VGA), extended graphics array (XGA), etc., or digital standards such as digital visual interface (DVI), high definition multimedia interface (HDMI), among others. A television display may comply with standards such as National Television System Committee (NTSC), Phase Alternating Line (PAL), or another suitable standard. Display 405 may include an output device 409, such as one or more integrated speakers to play audio content, or may include an input device 408, such as a microphone or video camera.

Storage 410 encompasses persistent and volatile media, fixed and removable media, and magnetic and semiconductor media. Storage 410 is operable to store instructions, data, or both. Storage 410 as shown includes sets or sequences of instructions, namely, an operating system 412, and a server deploying utility 414. Operating system 412 may be a UNIX or UNIX-like operating system, a Windows® family operating system, or another suitable operating system.

It is noted that in some embodiments device 400 represents a computing device 104, shown in FIG. 1. In some cases, server deploying utility 414 may be configured to provide functionality described in process 300 (see FIG. 3).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for deploying a server system, comprising:
establishing a network connection to a pre-installed global operating system of the server system; and
creating a local zone on the server system using the network connection based on first user input indicating desired properties of the local zone, wherein said creating the local zone further comprises:
creating at least one disk group for use with the local zone;
assigning the at least one disk group to the local zone based on second user input indicating a desired disk group;
configuring at least one logical volume on the local zone based on third user input indicating an assigned disk group and desired properties of a logical volume; and
configuring at least one file system on the at least one logical volume based on fourth user input indicating desired properties of a file system.

2. The method of claim 1, wherein said creating at least one disk group further comprises:
assigning logical unit numbers (LUN) respectively representing logical partitions provided by a storage-area network to the at least one disk group.

3. The method of claim 1, wherein said creating at least one disk group comprises:
assigning an LUN representing a logical partition provided by at least one local storage device to the at least one disk group.

4. The method of claim 1, wherein the desired properties of the local zone include a zone identifier, a physical interface, and a central processing unit utilization factor.

5. The method of claim 1, wherein the desired properties of the logical volume include a volume identifier and a volume size.

6. The method of claim 1, wherein the desired properties of the file system include a file system mount point.

7. The method of claim 1, wherein said creating the local zone further comprises:
adding user accounts on the local zone based on fifth user input indicating user account information.

8. The method of claim 1, wherein said creating the local zone further comprises:
configuring an application on the local zone, wherein the application accesses the at least one file system.

9. The method of claim 8, wherein said creating the local zone further comprises:
rebooting the local zone; and
executing the application from the local zone.

10. A computing device for deploying a server system, comprising:
a processor;
a network adapter; and
memory media accessible to the processor, including processor executable instructions to:
use the network adapter to establish a network connection to a pre-installed global operating system of the server system; and
create a local zone on the server system using the network connection responsive to receiving user input, wherein the local zone is configured to provide access to at least one file system mounted on at least one disk group available to the local zone.

11. The system of claim 10, wherein the user input is a first user input indicating desired properties of the local zone, and further comprising processor executable instructions to:
create at least one disk group for use with the local zone.

12. The system of claim 11, wherein the desired properties of the local zone include a zone identifier, a physical interface, and a central processing unit utilization factor.

13. The system of claim 10, wherein said processor executable instructions to create the local zone include processor executable instructions to:
assign the at least one disk group to the local zone responsive to receiving second user input indicating a desired disk group.

14. The system of claim 13, wherein said processor executable instructions to create the local zone include processor executable instructions to:
configure at least one logical volume on the local zone responsive to receiving third user input indicating an assigned disk group on which the logical volume is configured.

15. The system of claim 11, wherein said processor executable instructions to create at least one disk group further comprise processor executable instructions to:
assign logical unit numbers respectively representing logical partitions on a storage-area network to the at least one disk group.

16. The system of claim 14, wherein said processor executable instructions to create the local zone include processor executable instructions to:
configure at least one file system corresponding to the at least one logical volume responsive to receiving fourth user input indicating desired properties of a file system.

17. The system of claim 16, further comprising processor executable instructions to:
reboot the local zone; and
execute an application from the local zone, wherein the application accesses the at least one file system.

18. Computer-readable memory media, including executable instructions for deploying a server system, said instructions executable to:
establish a network connection to a pre-installed global operating system of the server system;
create at least one disk group for use with a local zone;
create the local zone responsive to receiving first user input indicating desired properties of the local zone;
assign the at least one disk group to the local zone responsive to receiving second user input indicating a desired disk group;
configure at least one logical volume on the local zone responsive to receiving third user input indicating an assigned disk group on which the logical volume is configured; and
configure at least one file system on the at least one logical volume responsive to receiving fourth user input indicating desired properties of a file system;
wherein the first, second, third, and fourth user inputs are used to generate instructions for sending over the network connection.

19. The memory media of claim 18, wherein the desired properties of the logical volume include a volume identifier and a volume size.

20. The memory media of claim 18, wherein the desired properties of the file system include a file system mount point.

21. The memory media of claim 18, further comprising instructions executable to:
add user accounts on the local zone responsive to receiving fifth user input indicating user account information.

22. The memory media of claim 18, further comprising instructions executable to:
reboot the local zone; and
execute an application from the local zone, wherein the application accesses the at least one file system.
